(19) United States
(12) Patent Application Publication
(10) Pub. No.: US 2011/0308925 A1
(43) Pub. Date: Dec. 22, 2011

(54) Push switch

(76) Inventor: Takahisa Kitahara, Isesaki-shi (JP)

(21) Appl. No.: 13/065,986

(22) Filed: Apr. 4, 2011

(30) Foreign Application Priority Data
Jun. 18, 2010 (JP) 2010-138901

(51) Int. Cl. H01H 13/06

(52) U.S. Cl. 200/302.2

(57) ABSTRACT

A side wall and a top wall are integrally formed at the interior of a tubular case, which houses a switch. A cap member is fitted on the top of this case, and a flexible seal member is mounted on the top wall by way of a seal cover having a corner portion which is formed as a curve.

### BACKGROUND OF THE INVENTION

1. Field of the Invention

The present invention relates to a push switch having a waterproof function.

2. Description of the Related Art In terms of waterproof and airtight push switches, for example, Japanese Patent Laid-Open Publication No. 2009-146806 describes, as shown in FIG. 4, a push switch 110 comprising a base 111, a switch main body 112 disposed on the base 111, a key top 114 disposed on the switch main body 112, and a case 115, which houses the switch main body 112, wherein an elastic engagement member 113 is provided between the switch main body 112 and the key top 114, which is in close contact with the inner peripheral face of the case 115 and holds the key top 114.

Furthermore, Japanese Patent Laid-Open Publication No. 2004-327126 describes, as shown in FIG. 5, a push switch that is covered by a switch cap 124, which serves to ensure the waterproofness and moisture resistance of a switch 123, which is pushed by a boss portion 122 of a button 121.

This switch cap 124 is fitted into the peripheral edge of an opening in a switch case 126, which is fixed in an outside door handle 125. A switch plate 127 is further fitted on this switch case 126.

With the push switch 110 in FIG. 4, because an elastic engagement member 113 is provided in close contact with the inner peripheral face of the case 115, between the switch main body 112 and the key top 114, the gap where the key top 114 is exposed is eliminated, whereby ingress of moisture and dust can be prevented.

However, there is a problem in so much as the reliability of the waterproof function suffers because, if the key top 114 is pushed with excessive force, it is possible that the elastic engagement member 113 will be damaged as a result of fissures resulting from undue elongation of the thin portions of the elastic engagement member 113, and as a result of contact with the corners of the switch main body 112.

Furthermore, if the key top 114 is pushed with excessive force, an excessive force will act on the switch main body 112 and the switch board, and there is a risk of these breaking.

Meanwhile, with the push switch in FIG. 5, if the button 121 is pushed with an excessive load, an end face 128 of the button 121 makes contact with an end face 129 of the switch plate 127 and the pressing load is transmitted to the bottom part of the switch case 126 and is thus relieved to the load bearing portion 130 of the outside handle 125, which abuts the switch case 126, whereby the excessive load does not act on the pushing part of the switch 123.

However, there were problems in that, because the button 121 and the switch case 126 are completely separated, the push switch lacks general-purpose versatility, and the production characteristics are inferior because, when this is mounted, it is necessary to align the button 121 and the switch case 126.

Furthermore, if the button 121 is pushed with an excessive load obliquely from above as seen in the drawing, there is a risk of the thin portion 131 and the boss portion 122 being damaged as a result of fissures, due to the thin portion 131 of the button 121 being unduly elongated and the thin portion 131 and the boss portion 122 of the button 121 contacting the corners of the opening in the switch plate 127.

### SUMMARY OF THE INVENTION

Thus, an object of the present invention is to provide a push switch having a highly durable and reliable waterproof function.

In order to achieve the aforementioned objective, the push switch of the present invention comprises: a switch board 30; a switch 40, which is disposed on the switch board, and which has an actuation part 41 at the top; a case 20, having a tubular portion that houses the switch board 30 and the switch 40, and a side wall 23 and a top wall 24, integrally formed at the interior of the tubular portion, and further having an opening 26 in the top wall; a flexible cap member 10, fitted on top of the case 20; and a flexible seal member 50, disposed on the top wall 24, and having a thick button part 52; and a hard seal cover 60, which fixes the seal member 50 in place on the top wall 24, and which is disposed with a space provided with respect to the inside of the cap member 10; wherein the seal cover 60 has a top portion 61, which is provided with an opening 63 and a peripheral side portion 62, and further has a corner portion 65, which is formed as a curve where the top portion and the peripheral side portion intersect; and the bottom face of the button part 52 faces the actuation part 41, via the opening 26 in the top wall 24, and the top face of the button part 52 faces the inner face of the cap member 10, via the opening 63 in the top portion 61.

In order to achieve the aforementioned objective, another push switch of the present invention comprises: a switch board 30; a switch 40, which is disposed on the switch board, and which has an actuation part 41 at the top; a case 20, having a tabular portion that houses the switch board 30 and the switch 40, and a side wall 23 and a top wall 24, integrally formed at the interior of the tubular portion, and further having an opening 26 in the top wall; a flexible cap member 10, fitted on top of the case 20; and a flexible seal member 50 mounted on the top wall 24, and having a thick button part 52, and which is disposed with a space provided with respect to the inside of the cap member 10; wherein the bottom face of the button part 52 faces the actuation part 41, via the opening 26 in the top wall 24, and the top face of the button part 52 faces the inner face of the cap member 10.

With the push switch of the present invention, it is possible to effectively prevent damage to the flexible cap member 10 that is pushed, and to effectively prevent damage to the switch 40 and the switch board 30, by preventing excessive force from acting on these, so as to provide a push switch having better durability and reliability. Furthermore, by fitting both the cap member 10 and the seal member 50 in the case 20 and arranging the seal member 50 at the inside of the cap member 10, it is possible to achieve a more reliable waterproof function for the interior of the case 20, without increasing the number of p.

### BRIEF DESCRIPTION OF THE DRAWINGS

FIG. 1 is a drawing of a push switch according to a first mode of embodiment of the present invention, wherein (a) is a plan view and (b) is a sectional view along the line A-A in (a).

FIG. 2 is a sectional view serving to describe the operation of the push switch in FIG. 1.

FIG. 3 is a sectional view of a push switch according to a second mode of embodiment of the present invention.

FIG. 4 is a sectional view of a conventional push switch.

FIG. 5 is a sectional view of another conventional push switch.

### DESCRIPTION OF THE PREFERRED EMBODIMENTS

Hereafter, modes of embodiment of the present invention will be illustratively described based on the drawings, however, the present invention is not limited to these exemplary modes of embodiment, but rather can be carried out with suitable modifications without departing from the gist thereof.

### First Embodiment

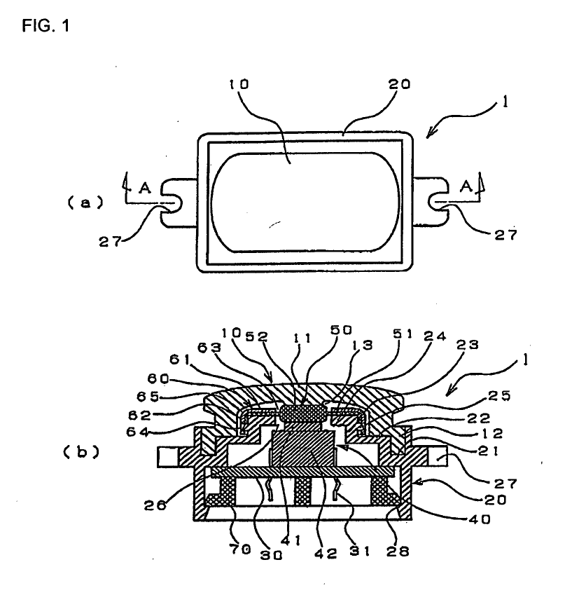

FIG. 1 shows a push switch 1 according to this example, wherein FIG. 1(a) is a plan view, and FIG. 1(b) is a sectional view along line of A-A in FIG. 1(a).

The push switch 1 of this example is mounted in a vehicle door handle device, which is not shown in the drawing. When a user operates a door lock device, a cap member 10 of the push switch 1 that is exposed by the vehicle door handle device is pushed, whereby the door can be locked or unlocked.

The push switch 1 according to this example comprises a cap member 10, a case 20, a switch board 30, a switch 40, a seal member 50, a seal cover 60 and a stopper 70.

The cap member 10 is formed from an elastically flexible resin, such as rubber, and comprises a substantially rectangular top actuation wall 11 and, descending vertically from the peripheral edge thereof, a peripheral side wall 12, having an opening at the bottom. Furthermore, an actuation protrusion 13 is provided on the bottom of the top actuation wall 11, in the center thereof.

A case 20 is formed in a tubular shape from a hard resin, at the interior of which a stepped portion 22 that forms a recess 21, a side wall 23, which continues from this stepped portion 22, and a top wall 24 are integrally formed.

The stepped portion 22, the side wall 23 and the top wall 24 are configured so as to cover a switch 40, which is described hereafter. A plurality of protrusions 25 are provided on the outer peripheral face of the side wall 23, and an opening 26 is provided in the center of the top wall 24.

The cap member 10 is fitted on the top of the case 20 with the bottom end of the peripheral side wall 12 fitted into the recess 21.

Mounting holes 27, for mounting on a door handle, which is not shown in the drawing, are provided at the outside of the case 20, and the push switch 1 is attached to the inside of the door handle via the mounting holes 27, so that the top actuation wall 11 of the cap member 10 is exposed to the exterior.

The switch 40 is disposed on the switch board 30. The switch board 30 and the switch 40 are housed within the case 20, with the top face of the switch board 30 abutting the bottom face of the stepped portion 22 of the case 20.

The switch 40 comprises an actuation part 41 and a main body part 42. The actuation part 41 protrudes from the interior of the main body 42, being configured so as to be mobile in the vertical direction as seen in the drawing, and being biased in the upward direction as seen in the drawing, by an elastic member, not shown in the drawing, within the main body 42.

When the actuation part 41 is pushed, the switch 40 is turned on, and a signal is transmitted to the exterior by lead wires, which are not shown in the drawing, via connection terminals 31, which are fixed in place on the switch board 30.

The seal member 50 is formed in a cap shape from an elastically flexible resin, such as rubber, and is provided with a thin peripheral portion 51 and a thick button part 52, which protrudes upward and downward in the center of the peripheral portion 51.

The seal member 50 is mounted by way of a seal cover 60, so that the bottom side of the thick button part 52 is set into the opening 26, so as to close the opening 26 in the top wall 24.

The seal cover 60 is formed in a cap shape from hard resin and comprises a top portion 61, in which an opening 63 is provided, and a peripheral side portion 62, in which fitting holes 64 are provided.

The seal cover 60 is installed with the protrusions 25 on the side wall 23 fitted into the fitting holes 64, and arranged with a predetermined space (gap) provided with respect to the inside of the cap member 10.

Consequently, the top face of the button part 52 faces the actuation protrusion 13 that is provided on the inner face of the cap member 10, via the opening 63 that is provided in the seal cover 60, and is arranged so as to be in proximity to, or in contact with, the actuation protrusion 13. Furthermore, the bottom face of the button part 52 faces the actuation part 41 of the switch 40, via the opening 26 that is provided in the top wall 24, and is arranged so as to be in proximity to, or in contact with, the actuation part 41.

A corner portion 65 at the intersection between the top portion 61 and the peripheral side portion 62 of the seal cover 60 is formed as a gradual, exteriorly convex curve. The sectional shape of the corner portion 65 does not have to be a perfectly circular arc, and elliptical arcs and chamfered corners may be included as corner portions formed as curves.

The stopper 70 is formed from a hard resin and abuts the bottom face of the switch board 30, being fitted so as to latch within the case 20 on latch parts 28. Furthermore, after the stopper 70 has been fitted, a sealing agent may be applied to the bottom face of the stopper 70 so as to improve the waterproofing.

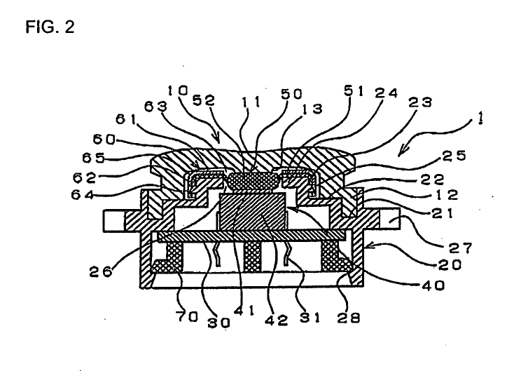

With the push switch 1 according to this example, which is configured as described above, as shown in FIG. 2, if the cap member 10 is pushed downwards from above as seen in the drawing, the cap member 10 itself is elastically deformed, so that the actuation protrusion 13 pushes the actuation part 41 downwards, via the button part 52, and the switch 40 is turned on.

If the cap member 10 is pressed straight down with an excessive force at this time, the inside of the top actuation wall 11 will bear against the flat top portion 61 of the seal cover 60 so that the inside of the cap member 10 will not be damaged and tearing of the flexible cap member 10 can be prevented.

Furthermore, because the stroke of the cap member 10 is limited by the seal cover 60, it is possible to prevent an excessive load being applied to the switch 40. Furthermore, the seal cover 60 is supported by the side wall 23 and the top wall 24 which are formed integrally with the case 20, and therefore it is also possible to prevent an excessive load from being applied to the switch board 30.

Meanwhile, if the cap member 10 is pushed obliquely downwards, the cap member 10 is elastically deformed, and the actuation protrusion 13 pushes the actuation part 41 downwards, so that the switch 40 is likewise turned on.

Furthermore, at this time, if the cap member 10 is pushed obliquely downwards with an excessive force, because the insides of the top actuation wall 11 and the peripheral side wall 12 bear against the flat surfaces of the top portion 61 and the peripheral side portion 62, or the curved corner portion 65, of the seal cover 60, in the same manner as described above, the inside of the cap member 10 will not be damaged and tearing of the flexible cap member 10 can be prevented, and because the stroke of the cap member 10 is limited by the seal cover 60, it is also possible to prevent an excessive load from being applied to the switch 40 and the switch board 30.

Thus, with the push switch according to this example, because the seal cover 60, which is formed with a curved corner portion 65, is arranged with a predetermined space provided with respect to the inside of the cap member 10, it is possible to prevent damage to the cap member 10, while preventing the application of excessive force to the switch 40 and the switch board 30, so as to effectively, prevent damage to the same, and thus provide a push switch having better durability and reliability.

Furthermore, by fitting both the cap member 10 and the seal member 50 in the case 20 and disposing the seal member 50 within the cap member 10, it is possible to achieve a more reliable waterproof function for the interior of the case 20, without increasing the number of parts.

Furthermore, because a highly waterproof function is not required of the cap member 10, it is not necessary to fill the areas where the case 20 and the cap member 10 fit together with a sealing agent or the like having a low waterproofing ability, so that the manufacturing process can be simplified.

### Second Embodiment

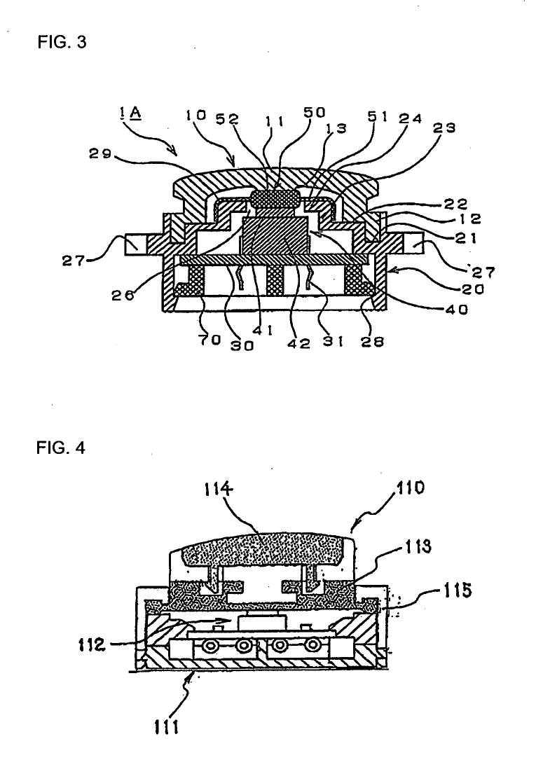

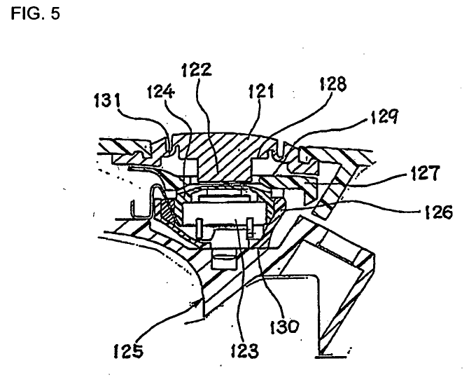

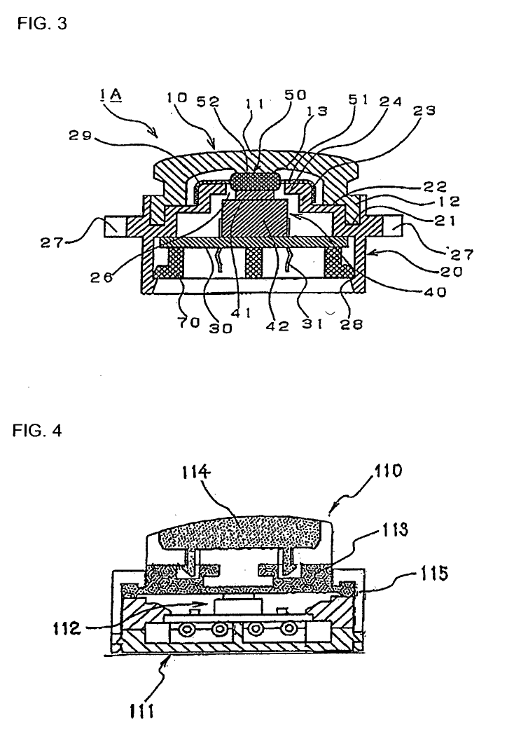

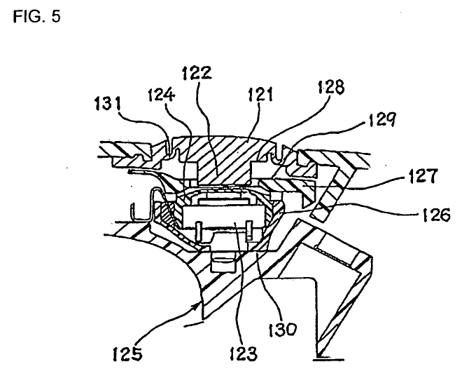

FIG. 3 is a sectional view of a push switch 1A according to this example. In FIG. 3, identical reference numerals have been used for components identical to those in the first mode of embodiment, and redundant description of the same has been omitted.

The points in this example that differ from the first mode of embodiment are that a corner portion 29 at the intersection between the side wall 23 and the top wall 24 of the case 20 is formed as a curve, and the seal member 50 is mounted affixed to the side wall 23 and the top wall 24, without using the seal cover 60 shown in FIG. 1.

With the push switch 1A according to this example, the top face of the button part 52 faces the actuation protrusion 13, which is provided on the inner face of the cap member 10, and arranged so as to be in proximity to, or in contact with, the actuation protrusion 13. Furthermore, the bottom face of the button part 52 faces the actuation part 41 of the switch 40, via the opening 26 that is provided in the top wall 24, and is arranged so as to be in proximity to, or in contact with, the actuation part 41.

With the push switch 1A according to this example, which is configured as described above, if the cap member 10 is pressed with excessive force, the inside of the top actuation wall 11 bears against the peripheral portion 51 of the flexible seal member 50, which is affixed to the side wall 23 and the top wall 24, which have the curved corner portion 29, whereby the inside of the cap member 10 will not be damaged at all and tearing of the cap member 10 can be more reliably prevented.

Furthermore, as in the first mode of embodiment, the stroke of the cap member 10 is limited, whereby it is possible to prevent an excessive load from being applied to the switch 40 and the switch substrate 30.

In addition, it is possible to achieve a reliable, highly waterproof function for the interior portion of the case 20, while reducing the number of parts, as compared to that in the first mode of embodiment. Furthermore, because a highly waterproof function is not required of the cap member 10, it is not necessary to fill the areas where the case 20 and the cap member 10 fit together with a sealing agent or the like having a low waterproofing ability, so that the manufacturing process can be simplified.

Note that, with the push switches 1 and 1A described above, an actuation protrusion 13 is provided at the center of the bottom of the top actuation wall 11, but the actuation protrusion 13 does not necessarily have to be provided in a mode wherein the bottom face of the top actuation wall 11 pushes the actuation part 41 downward, via the button part 52, so that the switch 40 can be turned on.

What is claimed is:

1. A push switch comprising:
a switch board;
a switch means which is disposed on said switch board and which has an actuation part at a top thereof;
a case having a tubular portion that houses said switch board and said switch means and a side wall and a top wall integrally formed at an interior of said tubular portion, and further having an opening in said top wall;
a flexible cap member fitted on a top of said case;
a flexible seal member disposed on said top wall and having a thick button part; and
a hard seal cover which fixes said seal member in place on said top wall, and which is disposed with a space provided with respect to an inside of said cap member;
wherein,
said seal cover has a top portion which is provided with an opening and a peripheral side portion, and further has a corner portion which is formed as a curve, where said top portion and said peripheral side portion intersect; and
a bottom face of said button part faces said actuation part via said opening in said top wall, and a top face of said button part faces an inner face of said cap member, via said opening in said top portion.

2. A push switch comprising:
a switch board;
a switch means disposed on said switch board, and which comprises an actuation part at a top thereof;
a case, having a tubular portion that houses said switch board and said switch means and a side wall and a top wall integrally formed at an interior of said tubular portion, and further having an opening in said top wall;
a flexible cap member fitted on top of said case; and
a flexible seal member mounted on said top wall and having a thick button part, and which is disposed with a space provided with respect to an inside of said cap member;
wherein,
a bottom face of said button part faces said actuation part via said opening in said top wall and the top face of said button part faces an inner face of said cap member.
